(19) United States
(12) Patent Application Publication
(10) Pub. No.: US 2005/0088587 A1
(43) Pub. Date: Apr. 28, 2005

(54) Direct-light illuminating backlight unit with a reflective structure for a liquid crystal display

(76) Inventors: John C. Pan, Taichung (TW); Chih-Kuang Chang, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/692,814

(22) Filed: Oct. 27, 2003

(51) Int. Cl. G02F 1/1335

(52) U.S. Cl. 349/65

(57) ABSTRACT

A direct-light illuminating backlight unit with a reflective structure for a liquid crystal display has a case with a back, at least one lamp mounted in alignment with the back, a reflective layer formed on the back and facing the lamp. The case has a front opening that has at least one brighter region immediately in front of the lamp and at least one dimmer region away from the lamp. The reflective layer is composed of multiple reflective protrusions each has two inclined faces. Each inclined face projects light radiated backward from the lamp onto the dimmer region. Therefore, light emit from the illuminating backlight unit has a homogenous brightness.

### BACKGROUND OF THE INVENTION

1. Field of the Invention

The present invention relates to a direct-light illuminating backlight unit with a reflective structure for a liquid crystal display (LCD), and more specifically to an illuminating backlight unit providing a planar light source with homogenous luminance to improve the image quality of an LCD.

2. Description of Related Art

Liquid crystal displays (LCDs) are lightweight, slim and do not emit harmful radiation, etc. so the LCD is becoming more popular than the CRT display. The LCD basically has a liquid crystal panel and an illuminating backlight unit. Since the liquid crystal panel cannot emit light, the illuminating backlight unit is a necessary element of the LCD.

There are two types of illuminating backlight unit, generally speaking, the edge-light backlight unit and the direct-light backlight unit. The edge-light units are generally slimmer in size. However, the direct-light units have other advantages, such as higher brightness and better brightness uniformity.

With reference to FIG. 4, the edge-light backlight unit comprises a tubular lamp (60), a reflective sheet (62), a light guide plate (61) and an optical assembly (not numbered). The tubular lamp (60) is mounted inside a reflector (601). The light guide plate (61) has an edge (not numbered) exposed to the tubular lamp (60). The light guide plate (61) is located between the optical assembly and the reflective sheet (62). The reflector (601) projects light radiated from the tubular lamp (60) into the light guide plate (61). The light guide plate (61) is configured to transmit light from the tubular lamp (60) across the viewing area and, with the help of the reflective sheet, effectively deflect light towards the optical assembly. The optical assembly is composed of a diffuser sheet (63) and prism sheets (64) and is located between a liquid crystal panel (50) and a light guide plate (61). When the light passes through the optical assembly, the light is smeared and dispersed, and forms a uniform planar light source for the liquid crystal panel (50).

In the edge-light backlight unit, tubular lamp is mounted at the edge of the light guide plate so the illuminating backlight unit is slim, generally speaking. However, for large size LCDs, the edges of a light guide plate does not provide enough light entrance area for forming a bright enough planar illuminating surface. Especially for applications of a LCD TV, say for example.

With reference to FIG. 5, a conventional direct-light backlight unit in accordance with the prior art comprises a case (70), multiple tubular lamps (71) and a diffuser plate (72). The case (70) has a back (701) and a front opening (702). The tubular lamps (71) are mounted inside the case, and align with the back (701), as illuminating sources. The front opening (702) is covered by a diffuser plate (72) to disperse and smear the emitting light from the lamps, and to make it a homogeneous planar illuminating unit.

Without proper treatment with the diffuser plate (72), the lamps (71) would be clearly visible from the backlight unit. Specifically, brighter areas (not numbered) correspond to the lamps (71), and dimmer areas (not numbered) exist between adjacent lamps (71). Therefore, the diffuser plate (72) must be mounted on the case (70) over the opening (702). The diffuser plate (72), like a screen, can disperse the light from multiple tubular lamps (71) evenly when the diffuser plate is far enough from the tubular lamps (71). If the diffuser plate (72) is placed too close to the lamps (71), the diffuser plate cannot disperse the light properly, thus the bright and dim areas are clearly visible. Therefore, the direct-light backlight unit cannot be made to be slim.

To further increase the brightness (or luminance) of the planar light source, the back (701) of the case (70) is covered with a highly reflective layer (703) to redirect part of the light that radiates backwards from the tubular lamps (71) towards the front. The reflective layer (703) does not, however, discriminately project light towards dimmer areas between the tubular lamps (71). With reference to FIG. 2A, the brightness difference at the front opening (702) is still obvious.

Thus concluding from above, the direct-light backlight units can provide large size LCDs with high brightness. However, the multiple tubular lamps (straight or looped in shape) emit light radiantly. Hence, in the viewing area on the display where is direct in front of the lamps forms a brighter region, while, area in between the lamps forms a dimmer region. The unevenly distributed brightness across the viewing area of a liquid crystal display has an adverse effect on the quality of image shown.

The present invention provides a direct-light illuminating backlight unit for a liquid crystal display to mitigate or obviate the aforementioned problems.

### SUMMARY OF THE INVENTION

An objective of the present invention is to provide a planar, direct-light illuminating backlight unit with homogenous brightness to increase the image quality of a liquid crystal display.

Another objective of the present invention is to provide a low profile, slim direct-light illuminating backlight unit.

Other objectives, advantages and novel features of the invention will become more apparent from the following detailed description when taken in conjunction with the accompanying drawings.

### BRIEF DESCRIPTION OF THE DRAWINGS

FIG. 1 is a partial cross-sectional view of an illuminating backlight unit in accordance with the present invention;

FIG. 2A is a plot of luminance across a distance perpendicular to the lamps in direction of a direct-light backlight unit without reflective protrusion on the back reflective surface;

FIG. 2B is a plot of luminance across a distance perpendicular to the lamps in direction of a direct-light backlight unit with reflective protrusion on the back reflective surface in accordance with the present invention;

FIGS. 3A to 3D are bottom views of the illuminating backlight unit with lamp arrangements in accordance with the present invention;

FIG. 4 is n cross-sectional view of an edge-light backlight unit assembly with a liquid crystal panel in accordance with the prior art; and

FIG. 5 is an illustration of a direct-light backlight unit in accordance with the prior art.

### DETAILED DESCRIPTION OF THE PREFERRED EMBODIMENT

An illuminating backlight unit in accordance with the present invention has a reflective structure to effectively project reflected light onto dimmer region. Therefore, the illuminating backlight unit has homogenous luminance across the viewing area.

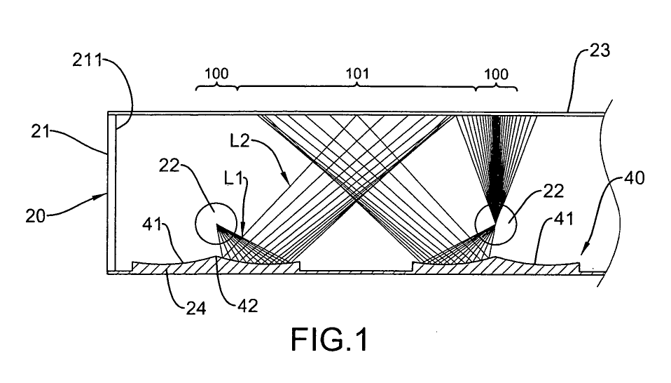

With reference to FIG. 1, the illuminating backlight unit has a thickness (not numbered), a case (20), at least one light-emitting source (22), a reflective layer (not numbered) and a light emitting face (not numbered) and optionally a diffuser plate (23).

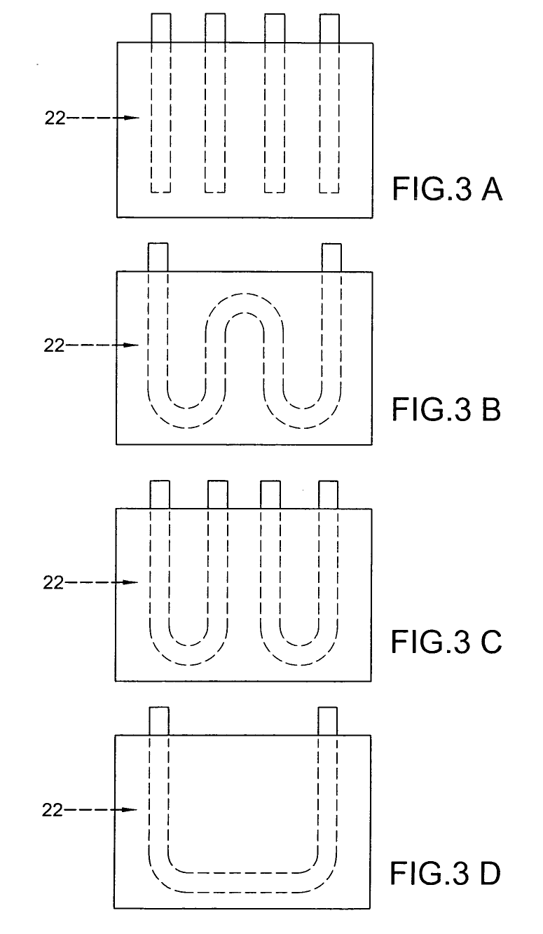

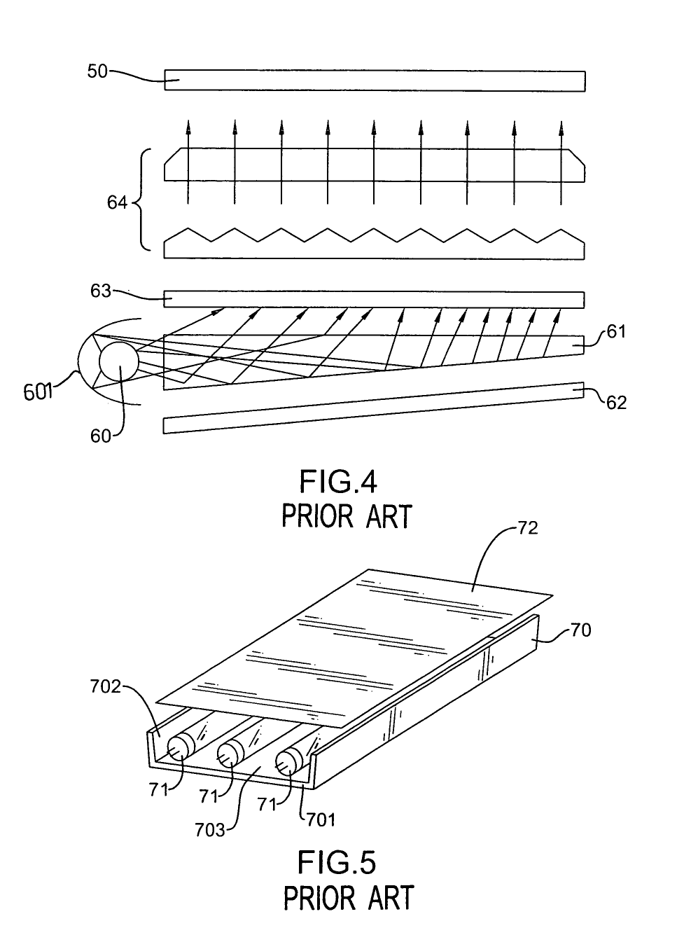

The case (20) has a frame (21), a back (24), and a front opening (211). The light emitting source (22) is mounted inside the case (20) align with the back (24), and a liquid crystal panel (not shown) is mounted in front of the illuminating backlight unit over the front opening (211) of the case (20). With further reference to FIGS. 3A to 3D, the light-emitting source (22) can be a straight tubular lamp or looped tubular lamp. The looped tubular lamp can be either in W shape, U shape, etc. On the light emitting face of a backlight unit, when the lamp (22) radiates light, the further away from the lamp has the lower illumination, thus forms uneven brighter regions (100) and dimmer regions (101). The brighter regions (100) are areas immediately in front of the lamps (22), and the dimmer regions are areas in between the lamps (101).

The reflective layer is mounted on the back (24) or formed integrated with the back (24). The reflective layer (not numbered) is composed of multiple reflective protrusions (40). Each reflective protrusion (40) corresponds to a lamp (22) and has at least one inclined face (41). In this embodiment, each reflective protrusion (40) has one salient (42) and two inclined faces (41). The salient (42) is aligned with the lamp (22), and each inclined face (41) is to project reflected light onto an adjacent dimmer region (101). Each inclined face (41) can be a flat, concave or convex surface.

Light (L1) radiated backward from the lamp (22) strikes the reflective layer and redirected forward as reflected light (L2). The reflected light (L2) is projected onto the dimmer region (101) by the inclined faces (41), which increases the brightness of the dimmer region. Therefore, the light from the lamp (22) can be effectively and evenly emit through the front opening (the light-emitting face) of the illuminating backlight unit.

To further adjust the distribution of luminance across the light-emitting face (viewing area), a diffuser plate (23) may be mounted on the frame (21) 111 over the front opening (211) to disperse the emitting light evenly. Therefore, the illuminating backlight unit can provide a planar light source with homogenous luminance. Since the luminance differences in between the brighter areas (100) and the dimmer areas (101) on the light emitting face is decreased by the help of the reflective protrusions (40), the diffuser plate (23) can be mounted closer to the lamp (22), and thus reduces the thickness of the illuminating backlight unit. In addition, a diffuser sheet (not shown) or prism sheets (not shown) can be laid on top to the diffuser plate (23) to further disperse the emitting light from the backlight unit.

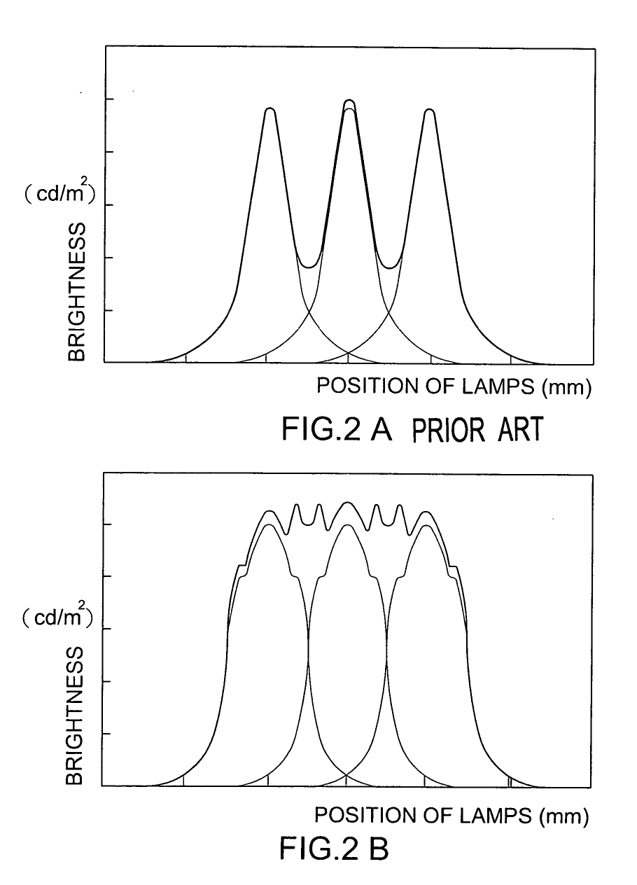

With reference to FIGS. 2A and 2B, the illuminating backlight unit in accordance with the present invention uses the reflective layer with multiple reflective protrusions, so the luminance distribution has shallower nulls than the prior art of conventional backlight.

Based on the forgoing description, the illuminating backlight unit in accordance with the present invention provides an emitting light with homogenous luminance across the light-emitting face (front opening) so the liquid crystal display may show images with good quality. Further, the brightness of the emitting light is first being averaged by the reflective protrusions so the distance between the diffuser plate and the lamp can be reduced, and thus reduces the total thickness of the illuminating backlight unit.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A direct-light illuminating backlight unit with a reflective structure for a liquid crystal display, comprising
a case having a front opening as a light-emitting face, a frame and a back connected to the frame, wherein the light-emitting face has at least one brighter region and at least one dimmer region;
at least one light-emitting source mounted inside the case align with the back, wherein the at least one brighter region is immediately in front of the light-emitting source and the at least one dimmer region is away from the light-emitting source forms a dimmer region; and
a reflective layer formed on the back and composed of multiple reflective protrusions, each reflective protrusion having at least one inclined face, wherein the reflective protrusion corresponds to the least one light-emitting source, wherein each inclined face projects reflected light onto the at least one dimmer region;
whereby light radiated backward from the at least one light-emitting source strikes the reflective layer, is projected toward the at least one dimmer region, and thus reduces uneven luminance between the at least one brighter region and the at least one dimmer region.

2. The illuminating backlight unit as claimed in claim 1, wherein each reflective protrusion has two inclined faces and a salient aligned with the corresponding light-emitting source, wherein each inclined face projects reflected light onto an adjacent dimmer region.

3. The illuminating backlight unit as claimed in claim 1, wherein the at least one light-emitting source is a tubular lamp.

4. The illuminating backlight unit as claimed in claim 1, wherein the at least one light-emitting source is a straight tubular lamp.

5. The illuminating backlight unit as claimed in claim 1, wherein the at least one light-emitting source is a looped tubular lamp in W shape.

6. The illuminating backlight unit as claimed in claim 1, wherein the at least one light-emitting source is a looped tubular lamp in U shape.

7. The illuminating backlight unit as claimed in claim 1 further comprising a diffuser plate mounted at the front opening to disperse outgoing light evenly.

8. The illuminating backlight unit as claimed in claim 7 further comprising a diffuser sheet laid on top the diffuser plate.

9. The illuminating backlight unit as claimed in claim 7 further comprising a prism sheet laid on top the diffuser plate.

10. The illuminating backlight unit as claimed in claim 2, wherein each inclined face is flat.

11. The illuminating backlight unit as claimed in claim 2, wherein each inclined face is concave.

12. The illuminating backlight unit as claimed in claim 2, wherein each inclined face is convex.

13. The illuminating backlight unit as claimed in claim 1, wherein the multiple reflective protrusions are formed integrally with the back of the case.
